(19) United States
(12) Patent Application Publication
(10) Pub. No.: US 2017/0332602 A1
(43) Pub. Date: Nov. 23, 2017

(54) SYSTEMS AND METHODS FOR BEHAVIORAL AND TASK TRAINING OF LABORATORY ANIMALS

(71) Applicants: Keith FENRICH, Edmonton (CA); Karim FOUAD, Edmonton (CA); The Governors of the University of Alberta, Edmonton (CA)

(72) Inventors: Keith FENRICH, Edmonton (CA); Karim FOUAD, Edmonton (CA)

(73) Assignee: The Governors of the University of Alberta, Edmonton, AB (CA)

(21) Appl. No.: 15/523,866

(22) PCT Filed: Nov. 4, 2015
(86) PCT No.: PCT/IB2015/058533

§ 371 Date: May 2, 2017

Related U.S. Application Data
(60) Provisional application No. 62/074,799, filed on Nov. 4, 2014.

(51) Int. Cl. A01K 15/02; A01K 29/00

(52) U.S. Cl. CPC A01K 15/021; A01K 29/005

(57) ABSTRACT

Systems and techniques for task training laboratory animals are described. The systems and techniques may be particularly useful for training laboratory rodents to perform a single pellet grasping (SPG) task. A system for training animals may include a task enclosure having a slit at one end. A system may include an automated pellet retrieval system. A system may include a sensor system. A system may include a computing device configured to receive data from a sensor system and cause pellet retrieval system to present a pellet to an animal. Further computing device may be configured to evaluate each task attempt.

### RELATED APPLICATIONS

This application claims the benefit of U.S. Provisional Application No. 62/074,799, filed on Nov. 4, 2014, which is incorporated by reference in its entirety.

### TECHNICAL FIELD

This disclosure relates to systems and methods for training animals and more particularly to task training laboratory animals.

### BACKGROUND

Spinal cord injuries, traumatic brain injuries, strokes, multiple sclerosis, and Parkinson's disease are among the most common neurological disorders in the world, and may result in devastating losses of motor control. Consequently, many laboratories throughout the world are studying these disorders in order to develop new and more effective therapies. To better understand the pathological mechanisms underlying these disorders and to test new therapeutic approaches for their treatment, many laboratories test motor function using animal models.

These motor function tests may be designed to examine the reaching, grasping, balancing, and/or the locomotor abilities of animals in a controlled setting. However, laboratories typically use one or more laboratory technicians to train each animal to perform a specific task and to collect data from the animals while the animals do the task. Such training and data collection techniques may be less than ideal.

### SUMMARY

In general, this disclosure describes techniques for training animals. In particular, this disclosure describes systems and techniques for task training laboratory animals. In some examples, systems and techniques are used for training laboratory animals to perform a single pellet grasping (SPG) task. In other examples, the systems and techniques described herein may be used to train animals to perform other tasks.

In one example, a device for training animals comprises a task enclosure, a pellet retrieval system, a sensor system, and a computing device configured to receive data from the sensor system and cause pellet retrieval system to present a pellet to an animal.

In one example, a non-transitory computer-readable storage medium comprises instructions stored thereon that upon execution cause one or more processors of a device to cause a pellet retrieval arm to move such that a pellet moves to a presentation position and evaluate an attempt by an animal to reach the pellet located at the presentation position.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example of a system that may implement one or more techniques of this disclosure.

FIG. 2 is an isometric view of an example single pellet grasping task enclosure that may implement one or more techniques of this disclosure.

FIG. 3 is an isometric view of a floor of an example single pellet grasping task enclosure and an example pellet retrieval system that may implement one or more techniques of this disclosure.

FIG. 4 is an exploded isometric view of a floor of an example single pellet grasping task enclosure illustrating sensors that may implement one or more techniques of this disclosure.

FIG. 5 is an isometric view of an example single pellet grasping task enclosure and an example pellet retrieval system that may implement one or more techniques of this disclosure.

FIG. 6 is an exploded view of an example pellet retrieval system and sensors that may implement one or more techniques of this disclosure.

FIGS. 7A-7B illustrate cross-sectionals of views of an example pellet retrieval system.

FIG. 8 is a flow chart illustrating example techniques for operating an example system according to one or more techniques of this disclosure.

FIG. 9 is a block diagram illustrating an example computing device that may implement one or more techniques of this disclosure.

### DETAILED DESCRIPTION

Skilled motor tasks are effective research methods for studying the neural control of skilled movement and motor recovery after nervous system injury and disease. There are a number of manually administered reaching and stepping tasks available for the study of forepaw movement in rodents including the Montoya staircase test, the well-grasping test, the Whishaw tray task, the horizontal ladder test, and the single pellet grasping (SPG) task. However, it can be difficult and time consuming to train animals to perform many of these tasks.

In the case of Montoya staircase testing, the rats must reach through slits in the right and left side of an enclosure to obtain pellets located in bowls at different depths relative to the slit openings. This test is higher throughput than manual SPG training and has the advantage of being able to compare effected to unaffected paw separately when using central nervous system (CNS) injury models. The Montoya staircase task is, however, a less complex task than the SPG task and it is difficult to differentiate between successes due to compensation and those due to motor recovery after CNS injury, making it hard to decipher the mechanisms of recovery. Similar to the Montoya staircase test, the hole-grasping task requires the rat to reach down through a deep hole in the floor to obtain food rewards. This test is comparatively simple and requires less training than manual SPG training, but it has had limited use compared to the other tasks and very little kinematic data can be acquired using this test. Horizontal ladder testing requires the rat to traverse a walkway in which the floor is replaced by a series of horizontal bars. Slips, forepaw missteps and kinematics are compared between treatment groups as a measure of forepaw motor function. Horizontal ladder testing requires less training than manual SPG training, but is not as specific a test for forelimb function because rat balance and slips from other limbs can have major effects on the forelimb of interest, especially in rats with CNS injuries.

The SPG task is a skilled forelimb motor task frequently used to evaluate rodent forelimb motor function. The SPG task is commonly used to evaluate reaching and grasp kinematics and recovery of forelimb function in rodent models of CNS injuries and diseases. The SPG task is important to assessing motor recovery following various CNS injury models such as cervical spinal cord injury, traumatic brain injury and stroke. The SPG task is commonly used in laboratories to test forelimb extension and finger dexterity/strength in animals with nervous system dysfunction in a controlled setting. Specifically, the SPG task tests whether an animal can extend a forelimb and grasp an object using its fingers, a common motion in everyday human activities, but which is often impossible or very difficult to do for individuals with spinal cord injury, traumatic brain injury, multiple sclerosis, Parkinson's disease, or who have suffered a stroke. SPG may be referred to as the “go-to” task to study motor learning and evaluate recovery from motor disorders including stroke, Parkinson's, multiple sclerosis, and spinal cord injury.

In some cases, to train rats in the SPG task, the animals are usually food restricted then placed in an SPG task enclosure and presented food pellets on a platform located beyond a slit located at the front of the task enclosure for 10-30 minutes, normally every weekday for several weeks. In some cases, the SPG task is performed in a long narrow enclosure similar to a covered corridor that is closed on all sides. Typically, a conventional enclosure has a narrow (e.g., approximately 1 cm) vertical slit in the middle of a wall at the front of the corridor. Beyond the slit is a holder (e.g., approximately 3 cm from floor level) upon which a food pellet is placed (e.g., approximately 2 cm beyond the slit). A holder may include a platform with groves or a pedestal (with or without a resistive force mechanisms, which may be referred to as a pinching mechanism). To complete the SPG task, the animal starts at the back of the enclosure (i.e., the end opposite the slit). The animal then moves to the front of the enclosure and reaches through the slit to retrieve a pellet. Once the pellet is retrieved, the animal must move to the back of the enclosure before the trainer places another pellet on the platform.

Typically the task is repeated for about 20 minutes per rat per daily session. The number of trials per session can vary greatly from rat-to-rat and day-to-day depending on the motivation of the animal, with a typical session ranging from 5-60 trials per day (with an average of about 30 trials). To be considered a ‘pass’ (or success), the animal must lift the pellet from the holder and bring it within the enclosure without dropping the pellet. A ‘fail’ is when the animal knocks the pellet from the holder or retrieves the pellet by sliding it along a platform and through the slit (called a ‘scoop’). The SPG task is considered complex and difficult for the animals, especially those with nervous system dysfunction, because it requires coordination between two forelimbs (one limb supports the animal while the other reaches), dexterity of the fingers (the pellets can only be retrieved by wrapping several fingers around the pellet), and precision (failure to raise the arm or place the paw at the precise time or in the correct location results in knocking the pellet from the platform).

Training a rat with an uninjured and disease free nervous system to perform the SPG task usually takes three to four weeks. A success rate of 30-40% may be achieved for a typical strain of rat. Training animals to perform this task is tedious, time-consuming, and expensive. Typically, the role of the trainer in the SPG task is to (1) place the animals in the testing enclosure, (2) entice the animals to perform the task, (3) evaluate each trial as a ‘pass’ or a ‘fail,’ (4) place a pellet on the platform for each trial, and (5) remove the animals from the enclosure to their home-cage after the session. These steps are typically repeated 20 minutes a day for each animal, five to six days a week, for three to four weeks.

The most likely reasons it takes several weeks of intensive training for the animals to learn the task is because of the brevity of each training session and the animals are often poorly motivated to perform the task. Poor motivation is likely because some animals (e.g., rats and mice) are nocturnal and are therefore more active and alert at night rather than during manual daytime training sessions. That is, training is frequently done during the animals' circadian day, which for nocturnal rodents, such as, mice and rats, could affect performance. When the SPG task is applied in studies involving various experimental groups, training may quickly become labor intensive, and can yield results with significant day-to-day variability. Typical training involves intensive one-on-one interaction with each animal, which is time consuming (several weeks per animal), expensive (the salary of the trainer), tedious, and variable between individuals and/or laboratories. Further, training an animal to perform the SPG task, or any other complex motor task, is difficult, produces highly variable results, and is considered tedious and quickly becomes monotonous for the trainer.

There are a number of additional drawbacks to conventional use of manually administered tasks. First, they can be procedurally time-consuming. As described above, in a conventional manually administered SPG task, a rat is placed within an SPG corridor task enclosure and must approach a narrow slit located in the wall at the front of the enclosure to grasp a food pellet located on a holder beyond the slit. In this SPG protocol, once the grasp attempt is complete the rat must return to the back of the enclosure before another pellet is placed on the holder. Second, the SPG task can be considered a complex motor task given that success rates are well below 100% even in the most well trained rats, and success rates vary with the rat strain. As a result of its complexity, implementation of the SPG task typically requires extensive one-on-one researcher-to-rat manual training, especially in animals with CNS injuries. Despite the valuable forelimb motor function data that can be acquired using the SPG task, given the extensive training time required the SPG task may not be well suited for high-throughput research such as drug screening studies. Third, the extensive one-on-one researcher-to-rat training can be a source of variation between labs, and even from day-to-day within the same study. This variability is due, in part, to the methods of individual trainers, but could also be due to variability in the time of day or week training was performed. A further contributor to success rate variability could be weekly training schedules. For instance, since training is rarely performed on weekends, success rates often follow a weekday cycle with lower success rates early in the week compared to later in the week. This weekly variation could be due to a variety of reasons, including the motivation of the animals that may have had ad libitum access to food for much of the weekend, or overall enthusiasm and motivation of the trainers at the beginning compared to the end of the week.

In a clinical setting it is well established that patients who receive intensive rehabilitation therapy after CNS injury have a more favorable prognosis of functional recovery compared to patients who receive minimal or no rehabilitation therapy. Thus, to study training related mechanisms in animal models, intensive training is important. Intensive hind limb training (stepping) in animals can be accomplished using semi-automated devices such as training wheels within the home-cage. Intensive forelimb training, however, has proven difficult since (1) activity levels and motivation are low during the daytime in rats, (2) because of the extensive amounts of researcher time required to perform manual training and testing, and (3) the lack of appropriate automated devices for SPG training. These procedural drawbacks raise the question of whether the use of an automated procedure adapted to the rat circadian cycle might reduce methodological variability and enhance performance.

This disclosure describes an example automated pellet presentation system that may be used to train and test rats in the SPG task that reduces some of the procedural weaknesses of manual training. In one example, the system may replace the requirement of a trainer for placing the animals in the testing enclosure, enticing the animals to perform the task, placing a pellet on the platform for each trial, and/or removing the animals from the enclosure to their home-cage after the session. Further, in one example the system may be configured to run continuously to allow the animals to train during their active night cycle, thus expediting the training process to three to four days. Moreover, in one example, the system may be configured such that the processes for evaluating each trial as a ‘pass’ or ‘fail’ is more efficient. In particular, in one example, the data captured during a training session may be presented to the trainer as an accelerated video (i.e., video viewed at an accelerated frame rate). Presenting data as an accelerated video may dramatically reduce the time required to evaluate each trial, thus increasing throughput. In other examples, other techniques may be used to evaluate each trial as a ‘pass’ or a ‘fail.’ Overall, the example system and techniques described herein may reduce the time spent with each animal, increase the speed of training, reduce the cost of training, and improve the quality of training. Further, the example system may be configured to allow the animals to train when they choose, at any time during the day and night.

In one example, an automated pellet presentation system includes a fully programmed and automated robot that trains laboratory animals to perform complex motor tasks and to collect data from these animals as they perform these tasks. In one example, the automated pellet presentation system presents tasty (i.e., highly palatable) food pellets (e.g., banana flavor) to animals in such a way that the animals must complete a specific motor task to obtain a pellet. Since the animals are driven to obtain the pellets, and the only way to obtain pellets is by completing the task, the animals train themselves, through trial-and-error, to perform the task. It should be noted that although the example automated pellet presentation system described herein is configured to train adult rats to perform the SPG task, in other examples the automated pellet presentation system may be configured to train other tasks and/or other animals (e.g., mice, etc.) to perform the SPG task and/or other tasks. It should be noted that although automation has been used to train animals to perform behavioral tasks (e.g., animal pushes a lever, animal gets an easily accessible reward, repeat), such automation has not been used to train animals to perform complex motor tasks, such as the SPG task.

It should be noted that there are technologies for training animals to obtain pellets using their forelimbs. One technology is referred to as trough training. In this training paradigm pellets are located in a hopper beyond a metal grate. To obtain a pellet the animal must reach through the grate and either grasp or scoop the pellets from the trough back to the home-cage. A second technology is a so-called ‘mouse reaching’ device that presents individual pellets to mice beyond a metal hole or grate. The device can be integrated into the home-cage, which allows the animals to practice obtaining pellets. Alternatively, the ‘mouse reaching’ device can be integrated into a task enclosure along with a sensor to count the number of pellets dropped compared to the number of attempts made over a period of time. In the case of both of these technologies the animals must use a forepaw to obtain pellets, and is thus considered a type of forepaw grasping task.

There are several major shortcomings of these technologies that limit their overall usefulness and several key differences between these technologies and the systems and techniques described herein: (1) Although both devices train animals to reach and obtain pellets with the forepaws, since the animals do not move from the front to the back of the cage between trials the devices do not train the animals to perform the SPG; (2) Moreover, since the animals do not move from the back of the cage to the front to obtain a pellet, these devices cannot be adapted to other locomotor tasks; (3) The trough device allows scooping of the pellets, therefore limiting its ability to train the animals to grasp; (4) The mouse reaching device presents pellets within a hole rather than on a pedestal. It is therefore not possible for the animals to knock or dislodge the pellet during an attempt. This simplification of the task therefore misses numerous failed trials, and allows the animals to develop non-grasping compensatory strategies that undermine the usefulness of the device as a rehab tool; (5) These devices do not require the animals to use their preferred and/or dysfunctional paw. This limits the usefulness of these devices in all studies in which forelimb motor function is damaged in only one limb (i.e., most spinal cord injury, traumatic brain injury and stroke studies); (6) These devices do not include a camera, thus precluding visualization of individual trials and qualitative analysis; (7) These devices cannot collect data while the animals have access to their home-cage. Although the trough-style devices are located exclusively within the home-cage, they are designed mainly to train animals to reach. In the case of the mouse reaching device, the mice must be transferred to a testing cage for data acquisition. As example of a mouse reaching device is automated mouse reaching chamber Model 80870 manufactured by Lafayette Instruments.

The example systems described herein may be configured to automatically present food pellets to animals in such a way that the animal must complete a motor task to retrieve a reward in the form of highly palatable food. At the same time, the system may collect data from the animals as they attempt the task. This approach may defer the high ongoing costs of paying the salaries of individuals to present pellets, to the one-time cost of purchasing the system. For example, it is estimated that salary costs of training are equivalent to one full-time technician per year (about $80,000). With the example systems and techniques described herein, high-throughput screening of treatments for neurological dysfunctions would be feasible and cost-effective.

In addition to the cost-effectiveness of the example systems described herein, the example systems described herein may have several scientific advantages over human trainers, such as, for example, (1) Unlike human trainers, the system may be configured to repeat the task in an identical way each and every time. That is, the pellet may be presented in the same way every time, whereas with humans they can, for example, move faster or make different sounds from trial to trial. Variability between trials and individuals performing the training can alter how the animals learn/perform the task, which skews the data and leads to erroneous conclusions. (2) Research animals such as rats and mice are nocturnal, and are therefore more alert and active at night. Unlike humans, the example systems described herein can repeat the task continuously or according to a pre-determined schedule regardless of the time of day, thus allowing the animals to self-train during the times that they are naturally alert and active. This represents a great advantage in that the animals can repeat the task more frequently and thus learn the task more rapidly. (3) Similar to humans, who are typically more comfortable in a familiar environment, animals have reduced stress when located within, or have easy access to, their home-cage. As described above, with traditional training approaches, animals are removed from their home-cage and placed in a training apparatus, which can lead to stress and affect task performance. To overcome these shortcomings, in one example, the system described herein can be attached directly to the animal's home-cage. This may enable the animal to explore and leave the task apparatus at any time, leading to reduced stress and improved behavioral performance. For example, manual training requires researchers to be in close contact with rats for long periods of time on a regular basis. Rats and mice are highly allergenic, meaning that trainers are at high risk of suffering allergic responses as a result of training these animals. The training techniques described herein may require minimal contact with the animals thus reducing the risk of contracting allergies from rats and/or mice.

In addition to the reduced stress of training within the home-cage, the example system described herein has several other ethical advantages over traditional manual training. First, the example system may provide an enriched environment for the animals since they can perform the task at any time of day and for extended periods of time. The environment may be further enriched with the visual feedback to their actions in the form of lights (e.g., a light turns on when a pellet is ready, and the light turns off when there is no pellet on the pedestal). In addition, training by a human is accomplished by food restricting the animal, with the idea that hungry animals will be more motivated to perform the task for a food reward. Results show that the example system can easily train the animals to perform the SPG task without food restriction, resulting in reduced stress for the animals and a more ethical test.

In one example, the system may be modular and can easily be modified to train animals in several different motor control tasks. For example, a solid floor can be replaced with a floor containing obstacles, a beam, or a horizontal ladder to study obstacle avoidance, balance, and paw placement during locomotion respectively. Alternatively, a level floor could be replaced by ramps or stairs to test and promote locomotion over difficult terrain. In examples including floor obstacles, the important part of the task may be moving along the altered terrain, so it may be desirable that the food pellets are easily accessible and could therefore be presented very close to a slit. Other reaching tasks might include presenting the pellets through holes in the floor, thus changing the orientation of the grasping motion. The depth of the pellets through the hole could be adjusted to control the difficulty of the task, and the holes could be placed along the edges of the enclosure to force the animals to use their non-dominant paw. It should be noted that while the example systems described herein are described with respect to training rats and mice, the example systems described herein may be modified to be suitable for other animal models (e.g., mouse and primate models).

Taken together, the example systems and techniques described herein represent a major advancement in the study of complex motor functions and rehabilitation therapy using animal models, reduces the overhead costs of conducting these studies, increases the throughput of these studies, reduces variability and can be used by a wide range of laboratories throughout the world. The example techniques described herein have been shown to have a much higher-throughput than manual SPG training. Reduced fine motor function can be a subtle, but important, side-effect of numerous drug treatments, and it is important to identify these potential side-effects are early stages of drug development using animal models rather than in expensive drug trials. Large scale drug screening studies often have many treatment groups and thus require automation for cost-effective and time-effective implementation. The high-throughput advantage of training techniques described herein make the techniques described herein suitable for testing skilled forelimb motor function as part of drug screening studies. It should be noted however that once promising drug candidates are identified for human trials, it can be difficult to compare rodent behavioral results to human clinical tests. For more direct comparisons between animal experiments and human trials, this task could be automated for humans giving a parallel rodent human research methodology.

In a clinical setting, rehabilitation therapy is one of the most useful and universally prescribed treatment strategies for CNS injuries such as stroke, spinal cord injury, and traumatic brain injury, and can be important in the treatment of for neurodegenerative diseases such as Parkinson's disease, multiple sclerosis, and dementia. Moreover, rehabilitation therapy is complimentary, and often necessary, for translating drug and cell treatments into meaningful functional recovery. Performing the SPG task is the equivalent of rehabilitation therapy for skilled forelimb motor function in the rat. Since CNS injury patients will almost certainly get rehabilitation therapy, it is important that all studies evaluating drug and cell treatment strategies include rehabilitation therapy to more fully mimic clinical approaches.

Moreover, drug and cell treatment studies often have multiple treatment groups, making it difficult to include rehabilitation therapy in these studies. The APP approach could be a time-effective and relevant approach for integrating rehabilitation therapy when testing the efficacy of drug and cell treatment strategies. The example training techniques described herein add enrichment and reduced food stress on the animals, is less work for researchers, more efficient, and allows one to explore training without time limitations or restrictions.

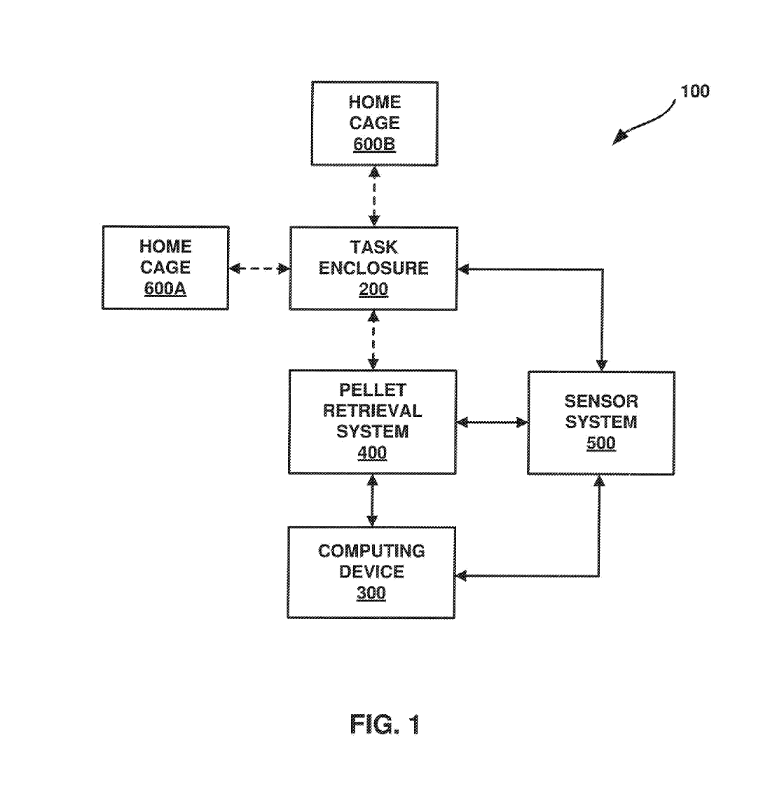

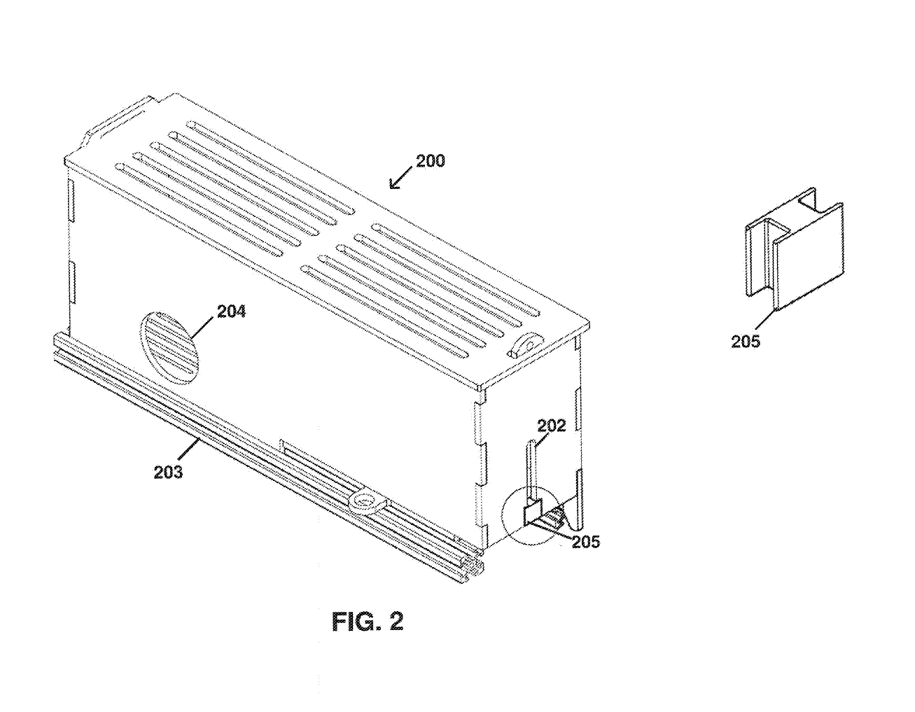

FIG. 1 is a block diagram illustrating an example of a system that may implement one or more techniques of this disclosure. System 100 represents an example of a system that may be configured to perform one or more of the techniques described herein. For example, system 100 represents an example of a system that may be configured to task train animals. In one example, system 100 may be configured to train laboratory animals to perform a task by automating one or more training aspects of a task. System 100 is described with respect to an example implementation illustrated in FIGS. 2-7B. With respect to the example implementation illustrated in FIGS. 2-7B, system 100 may be modular and designed such that it can be scaled up or down for SPG task training with either rats or mice. It should be noted that in other examples system 100 may be scaled up or down to meet the needs of a variety of other lab animals, such as non-human primates, cats, and other animals. Scaling may involve changing the size of all non-electronic components (e.g., task enclosure 200 dimensions) and, potentially, the size of the electromechanical components. Further, system 100 may be modular for adaptation to multiple tasks (e.g., SPG, ladder walk, stair climbing, combination thereof, etc.).

In the example illustrated in FIG. 1, system 100 includes task enclosure 200, computing device 300, pellet retrieval system 400, sensor system 500, and one or more home-cages 600A-600B. Task enclosure 200 represents an example of an enclosure configured to enable an animal to perform a particular task. In one example, task enclosure 200 may be configured to enable a rodent to perform a SPG task. As described above, for an SPG task, a task enclosure includes a long narrow enclosure with a narrow slit located in a wall at one end of the enclosure. FIG. 2 is an isometric view of an example single pellet grasping task enclosure that may implement one or more techniques of this disclosure. In the example illustrated in FIG. 2, task enclosure 200 includes a modular enclosure with four side walls (two side walls are shown in FIG. 2), a ceiling, and a floor (partially shown in FIG. 2). In one example, walls of enclosure 200 may include clear acrylic sheets connected by right-angle joint fasteners. The dimensions of task enclosure 200 may be based on the size on an animal and a training task. For example, in the example where a task includes an SPG task and an animal is a rat, task enclosure 200 may be approximately 45 cm long, 10 cm wide, and 30 cm tall.

In the example illustrated in FIG. 2, a front wall including slit 202 is illustrated and reach-guide 205 is illustrated. Task enclosure 200 includes a back wall (not shown) opposite front wall having the same dimensions as front wall, but without a slit. The reach-guide 205 is connected to the slit and can be moved vertically within the slit. The size of slit 202 and vertical location of the reach-guide 205 may be based on an animal being trained to perform a SPG task. In one example, when the animal is a rat, slit 202 may extend from the floor of enclosure 200 to a height of approximately 10 cm and may have a width of approximately 1 cm, and the reach-guide 205 may be positioned so that the top of the guide is 2 cm from the top of the front floor 208. As described in detail below, an animal may reach through slit 202 to retrieve a food pellet as part of an SPG task. As described in detail below, the reach-guide 205 helps guide the animals' paw towards the pellet pedestal and restricts access to regions below presentation position. In the example illustrated in FIG. 2, task enclosure 200 is removably coupled to frame 203. In the example illustrated in FIG. 2, frame 203 includes extruded aluminum bars having slots that enable components of task enclosure 200, pellet retrieval system 400, and sensor system 500 to be secure thereto and removed therefrom. In one example, frame 203 may include 20 mm extruded aluminum bars.

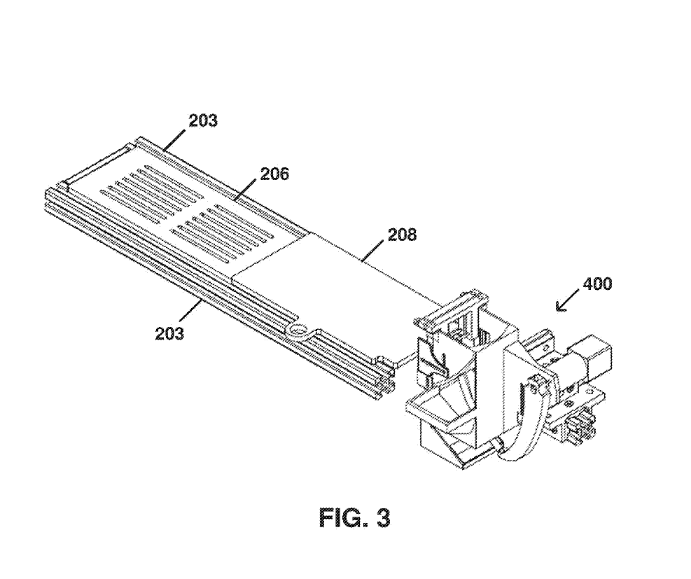

The example modular design of system 100 allows components of task enclosure 200, pellet retrieval system 400, and sensor system 500 to be easily removed and replaced, e.g., for faster and more effective cleaning and to enable different/modified training tasks. In some cases, rats may track bedding from a home-cage into task enclosure 200 which makes task enclosure 200 dirty and may affect performance of sensor system 500. As described above, task enclosure 200 includes a floor (partially shown in FIG. 2). FIG. 3 is an isometric view of a floor of an example single pellet grasping task enclosure and an example pellet retrieval system that may implement one or more techniques of this disclosure. In the example illustrated in FIG. 3, the walls and ceiling and reach-guide of task enclosure 200 are not shown in order to illustrate the floor of task enclosure 200. As illustrated in FIG. 3, the floor of task enclosure 200 includes back floor section 206 and floating floor section 208. In one example, the floor of task enclosure 200 may be raised (e.g., 10 cm) above a stationary surface (e.g., a lab bench) to accommodate other components of system 100 and/or to capture tracked bedding. In the example illustrated in FIG. 3, back floor section 206 includes an acrylic sheet having slots which may enable tracked bedding to fall through the back floor section 206. In one example, back floor section 206 may include a metal mesh. It should be noted that in some examples, back floor section 206 and floating floor section 208 may include floor sections including obstacles, a beam, or a horizontal ladder, etc.

Allowing tracked bedding to fall through back floor section 206 may increase the overall cleanliness of task enclosure 200. Further, one or more sensors of sensor system 500 may be located beneath floating floor section 208. In this case, bedding or other debris can get caught under the floating floor section 208, which may affect the readout from sensors. By having openings in back floor section 206, tracked bedding and other debris may be kept away from the sensors beneath floating floor section 208. It should be noted that if tracked bedding and other debris is allowed to pass through back floor section, in one example, drawers or other compartments may be included below the floor to catch any bedding or other debris that would otherwise fall to a stationary surface. These drawers can easily be emptied, which will facilitate cleaning of system 100.

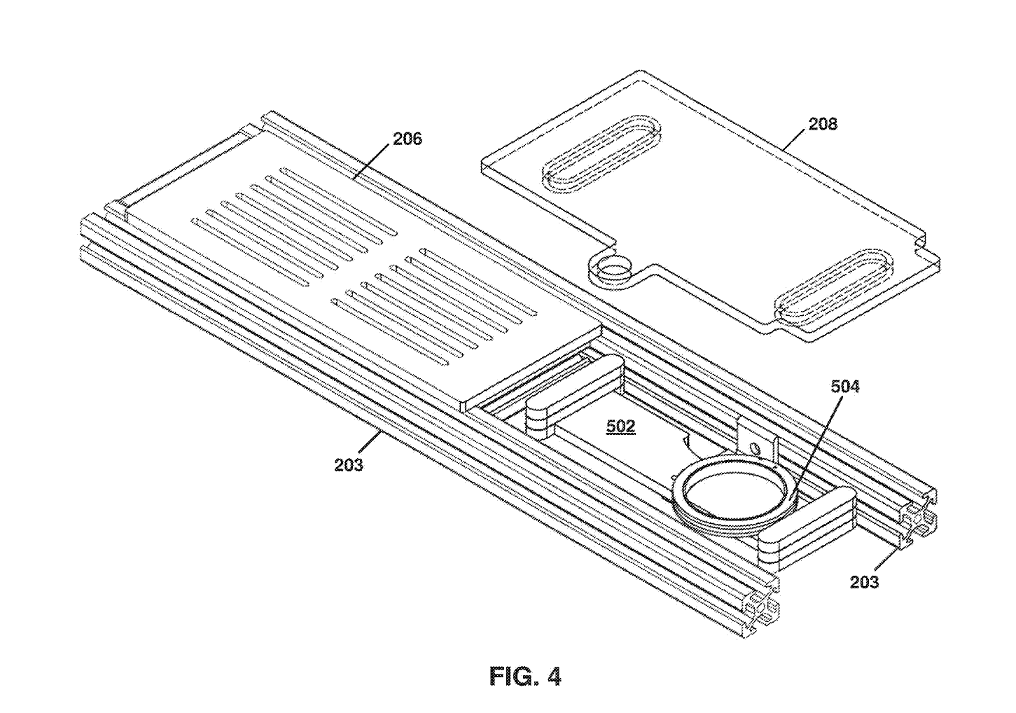

Floating floor section 208 may include a removable floor section. FIG. 4 is an exploded isometric view of a floor of an example single pellet grasping task enclosure illustrating sensors that may implement one or more techniques of this disclosure. Floating floor section 208 may be removed and cleaned, and the space between floating floor section 208 and back floor section 206 may be cleared of debris to maintain the reliability of sensor readings. Referring again to FIG. 1, sensors system 500 may include one or more sensors that may provide information about one or more animals within system 100. For example, sensor system 500 may provide locational information with respect to an animal. For example, sensor system 500 may provide information with respect to an individual animal within system 100 (e.g., indicate whether an animal is located within a home-cage 600A-600B or task enclosure 200). Further, sensor system 500 may provide locational information with respect to an individual animal's position within task enclosure 200 (e.g., indicate whether an animal is located within the front half of task enclosure 200) and may provide information with respect to an animal performing a task (e.g., indicate whether an animal is attempting to reach a pellet). In addition, in one example, sensor system 500 may include one or more sensors that may be used to determine environmental conditions. For example, sensor system 500 may include sensors to monitor temperature, humidity, and light-intensity. Further, sensors such as accelerometers may be included to detect vibrations (e.g., a door closing) and/or microphones may be included to detect animal vocalizations and ambient noise. As described in further detail below, computing device 300 may be configured to receive data from sensor system 500 and cause pellet retrieval system 400 to perform an action (e.g., raise or lower a pellet retrieval arm) based on sensor data. As further described in detail below, computing device 300 may be configured to receive data from sensor system 500 and evaluate a task attempt by an animal (e.g., pass, fail, etc.).

In the example illustrated in FIG. 4, sensor system 500 includes sensors that enable computing device 300 to determine whether an animal is located near the front of task enclosure 200, i.e., near slit 202. In the example illustrated in FIG. 4, sensor system includes load cell 502 and radio frequency identifier (RFID) coil 504 located underneath floating floor section 208. As illustrated in FIG. 4, load cell 502 and RFID coil 504 are supported by frame 203 and as such, are independent of task enclosure 200. In this manner, load cell 502 and RFID coil 504 may easily be removed for cleaning, and/or replaced within new sensors or other types of sensors.

RFID coil 504 may be configured to indicate whether a particular animal is located in proximity to RFID coil 504 (and thus located near the front of task enclosure 200). In this example, animals within system 100 may be implanted with RFID transponders. The use of RFID allows system 100 to identify individual animals within the task enclosure 200 and to sort task data according to each animal. It should be noted that by being able to sort task data according to individual animals, multiple animals may be located in system 100 at a time. This may provide an enhanced social environment for the animals and increase training motivation compared to an individual animal being removed from a social environment (e.g., a home-cage with multiple animals) for a training session. Further, training multiple animals at a time may increase training efficiency (e.g., more animals may be trained using a single system during a time period).

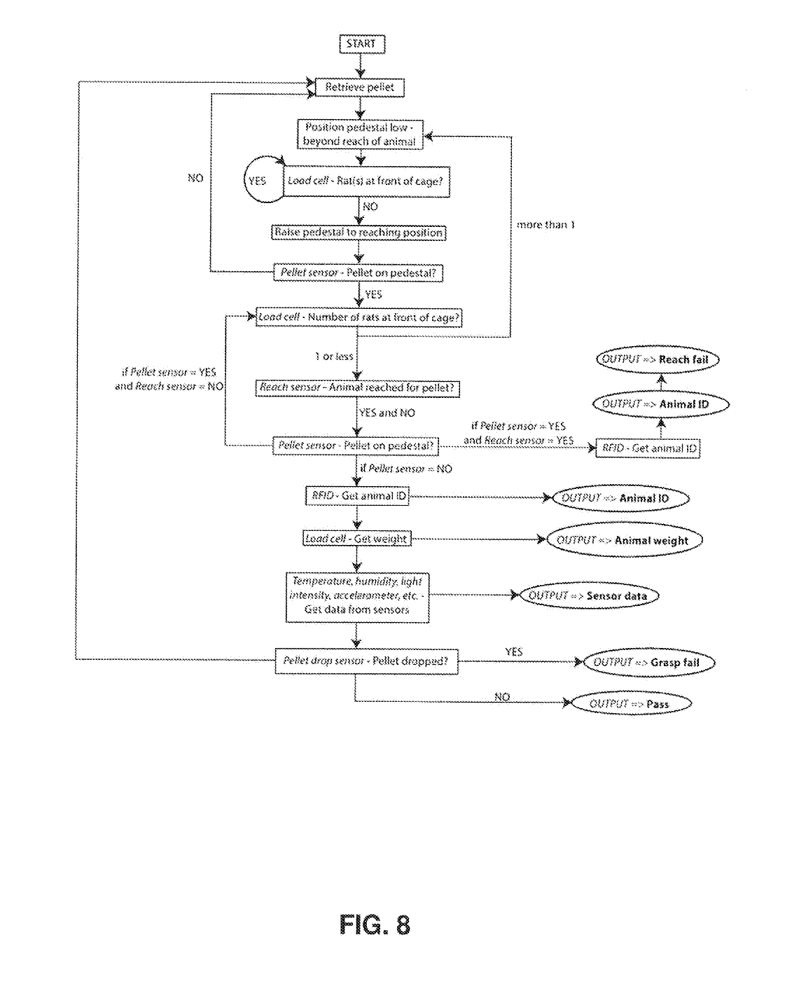

Referring again to FIG. 4, load cell 502 may be configured to determine if a single animal is located near the front of task enclosure 200. In the example illustrated in FIG. 4, load cell 502 may be configured to accurately measure a weight upon floating floor section 208. Data from load cell 200 may be used by system 100 to weigh individual animals and/or to determine whether one or more animals are located at the front of task enclosure 200. In one example, as described in further detail below with respect to FIG. 8, if computing device 300 detects that more than one animal is located at the front of task enclosure 200 based on data from load cell 504, a pellet is lowered below the level of the reach-guide 205 and out of reach and thus no trial occurs. This mechanism may limit the task to when only one animal is located at the front of task enclosure 200 (e.g., as indicated by data from load cell 502) to ensure that other animals do not interfere while an animal is performing the task. The description of FIG. 8 below provides additional details with respect to when a pellet may be presented based on data from load cell 502 and RFID coil 504.

It should be noted that in other examples, sensor system 500 may include other types of sensors to determine whether an animal is located near the front of task enclosure. These sensors, as well as, load cell 502 and RFID coil 504 may generally be referred to as animal location sensors. In one example, instead of load cell 502, force sensors may be located at the front of task enclosure 200. In one example, two large floor sensor pads may be included at each end of floating floor section 208. In another example, four smaller floor sensor pads may be located at each of the corners of the floating floor section 208. Pressure on the floating floor section 208 may activate the floor sensor pads, thus, indicating the presence of an animal. Floor sensor pads, may be useful when system 100 is configured to train a single large animal.

Further, in one example, instead of RFID coil 504, two or more proximity sensors may be located within a side wall of task enclosure 200. The location of the two proximity sensors can be adjusted to optimize the task parameters and to adapt to different tasks. In one example, one proximity sensor may be located near a home-cage port and a second proximity sensor may be located near slit 202. These sensors may be used to detect the location of the animals within task enclosure 200. Alternatively, for more precise localization of the animal, additional proximity sensors can be added along the side wall of task enclosure 200 or distance sensors can be used at either end of task enclosure 200. Additionally or alternatively, a proximity sensor (e.g., Phidgets 1103_1—IR Reflective Sensor 10 cm) may be positioned in the middle of task enclosure 200 to detect if animals (e.g., rats) are resting their forepaws on the floating floor section 208 (i.e., remain within the front half of task enclosure 208) without activating the floor sensors or the like. Combinations of the animal location sensors described herein may effectively detect the presence of an animal in a region of task enclosure 200.

Referring again to FIG. 2, task enclosure 200 includes a side wall including home-cage port 204. Task enclosure 200 includes a second side wall (not shown in FIG. 2) opposite the illustrated side wall. The second side wall may or may not include a home-cage port. Referring to FIG. 1, in one example, system 100 may include two home-cages. That is, system 100 includes home-cages 600A-600B. A home-cage may include any suitable animal habitat. For example, a home-cage may provide enrichment (e.g., in the form of a PVC tube and a small cedar block (3 cm×3 cm×3 cm) for rats), and ad libitum access to food and water. Home-cage port 204 enables task enclosure 200 to be operably coupled (e.g., through tubing (e.g., a 5 cm diameter PVC tube for rats)) such that one or more animals may move from one of home-cages 600A-600B to task enclosure 200.

It should be noted that although in some training scenarios it may be desirable for animals (e.g., rats) to have unrestricted access to their home-cage and task enclosure 200 24 hours a day, 7 days a week, except during cleaning times, in some case, restricting access to task enclosure 200 may improve training efficacy. That is, animals can lose interest in performing a task with time (i.e., perform fewer trials each day), but high daily trial-counts can be maintained by limiting access to task enclosure 200 for one day. Based on this observed animal behavior, allowing access to task enclosure 200 via each of home-cages 600A-600B, where each of home-cages 600A-600B house difference groups of animals, on alternate days (i.e., left home-cage on day one, followed by right home-cage on day two, then back to home-cage one on day three, etc.) may improve training efficacy. Access to/from task enclosure 200 and one or more of home-cages 600A-600B may be restricted (e.g., using a manual or automated gating mechanism) in accordance with a desired training schedule. For example, each home-cage may have a separate tube leading to task enclosure 200 and access to the task enclosure 200 may be controlled with doors that block the tubes. Alternating access to task enclosure may double the number of animals that can be trained per a task enclosure and increase overall attempt and success rates. It should be noted that rats typically perform well at a density of two to four rats per system per day.

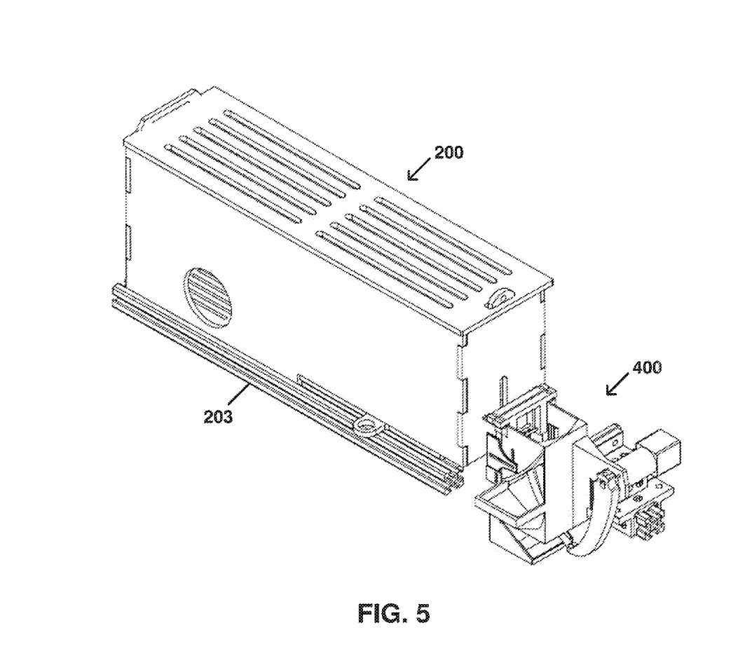

Referring again to FIG. 1, system includes pellet retrieval system 400. As illustrated in FIG. 5, pellet retrieval system 400 is located beyond slit 202, outside of task enclosure 200. As described above, computing device 300 may be configured to receive data from sensor system 500 and cause pellet retrieval system 400 to perform an action based on sensor data. Pellet retrieval system 400 may house pellets and cause pellets to be presented to an animal. Further, one or more sensors of sensor system 500 may be operably coupled to pellet system 400 such that each animal attempt may be evaluated. As illustrated in FIG. 3 and FIG. 4, pellet retrieval system 400 may be positioned along frame 203. In this manner, the location at which pellets are presented can be adjusted in 3D space (i.e., proximal-distal, medial-lateral, and up-down) relative to slit 202 by adjusting the position of the pellet retrieval system along frame 203. Adjusting the location of pellet presentation may help with training (e.g., pellets are first presented very close to slit 202 for easy access, and moved progressively further away to promote reaching), is useful for forcing the animal to grasp with a specific paw (described in more detail below), is useful for adapting the system for different sized rats (e.g., big rats can reach further than small rats), and can discourage scooping (e.g., the gap between the pedestal and reach-guide 205 can shortened or lengthened). In some examples, in the case of rats, pellets may presented at a distance of 1 to 2 cm from slit 202, up to 0.5 cm to the left or to the right of the center of slit 202, and/or 2 cm up from the level of the floor of task enclosure 200.

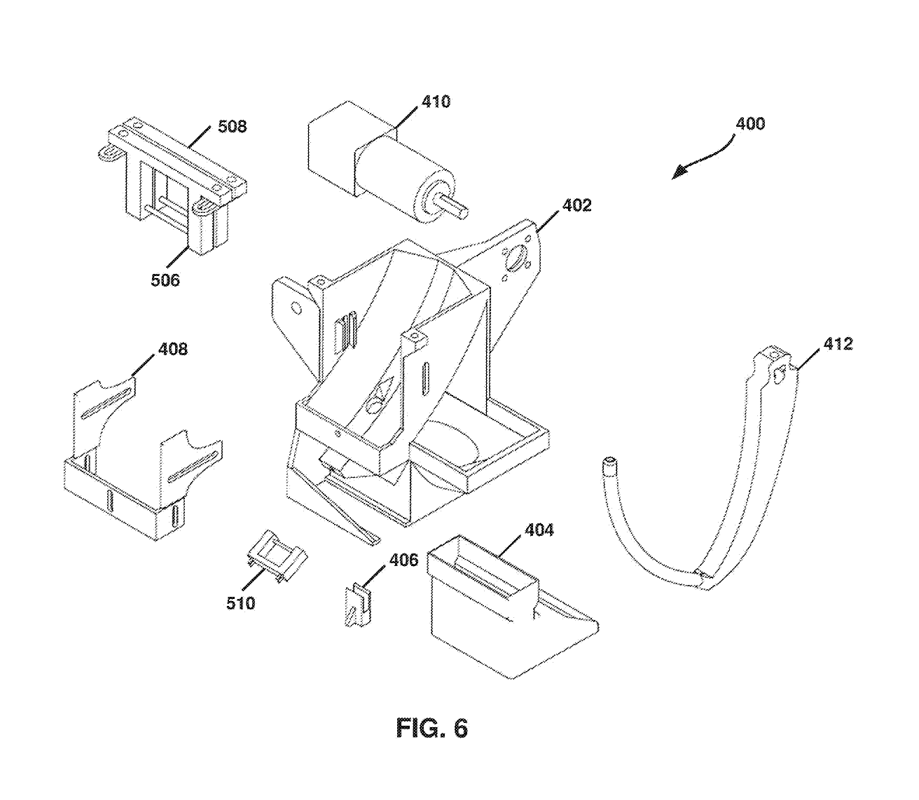

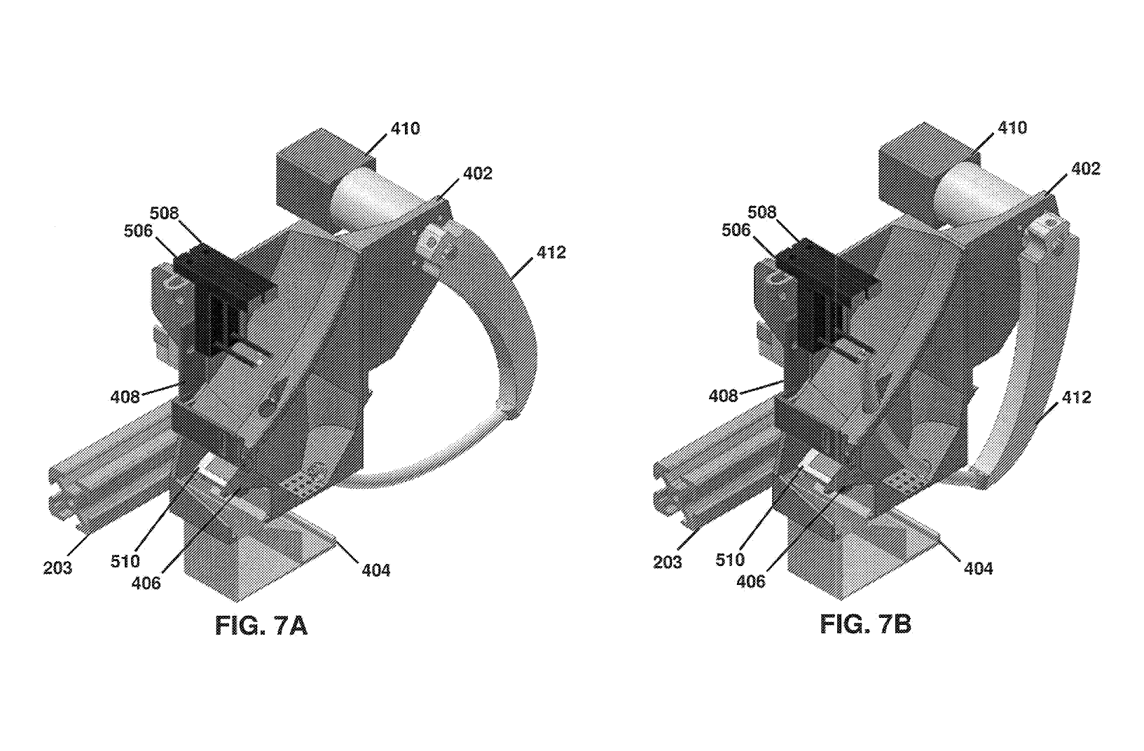

FIG. 6 is an exploded view of an example pellet retrieval system and sensors that may implement one or more techniques of this disclosure. FIGS. 7A-7B illustrate cross-sectionals of views of an example pellet retrieval system. Pellet retrieval system 400 includes pellet hopper 402, pellet container 404, adapter 406, pellet deflectors 408, pellet motor 410, and pellet retrieval arm 412. Further, sensor system 500 includes reach sensor 506, pellet present sensor 508, and pellet drop sensor 510 operably coupled to pellet retrieval system 400. Data from reach sensor 506, pellet present sensor 508, and pellet drop sensor 510 may be received by computing device 300.

Pellet hopper 402 is configured to store pellets from presentation and guide pellets through a chute, as describe in further detail below. Pellets are typically round and in one example, pellets may include banana flavored sugar pellets (e.g., 45 mg, TestDiet, 5TUT sucrose tab, rats pellets), banana flavored grain-based food pellets (e.g., 45 mg, Test Diet, 5TUM grain-based rodent tablet, rat pellets), or the like. It should be noted that mouse pellets are considerably smaller than rat pellets (i.e., 10-15 mg each for mouse pellets and 45 mg each for rat pellets). Pellet hopper 402 includes a loading chute which, in some examples, may be coupled to a pellet reservoir (not shown). In some examples, as pellets are depleted from the pellet hopper 402, pellet hopper 402 may be replenished from a pellet reservoir. Pellet hopper 402 and/pellet reservoir may be sufficiently sized to accommodate a task training session.

FIGS. 7A-7B illustrate cross-sectionals of views of an example pellet retrieval system. As illustrated in FIGS. 7A-7B, pellet hopper 400 includes an interior region where pellets may be stored and exterior region where a pellet may be presented. Pellet retrieval arm 412 may move from a first position illustrated in FIG. 7A through interior region of pellet hopper 400 to a second position illustrated in FIG. 7B such that a pellet may be retrieved and presented on the tip of pellet presentation arm 412. That is, a pellet rests on the tip of pellet arm 412 similar to a golf ball resting on a tee. It should be noted that the tip of pellet presentation arm 412 may be referred to as a pedestal or platform. Pellet retrieval arm 412 may be configured to accommodate multiple pellet sizes. That is, tip of pellet retrieval arm 412 may be removable and each tip attached to pellet retrieval arm 412 may be configured to accommodate pellets having a specific diameter.

When a pellet is resting on the tip of pellet retrieval arm 412 and pellet retrieval arm 412 is in the position illustrated in FIG. 7A, the pellet may be consider to be presented to an animal and an animal may reach through slit 202 in order to attempt to retrieve a pellet. It should be noted that, unlike a traditional SPG platform that allows the rats to “scoop” the pellets along a flat surface towards a slit, the example system illustrated in FIGS. 7A-7B virtually eliminates scooping and requires the rat to grasp the pellet for retrieval. Eliminating scooping is important because scooping the pellet can be considered a compensatory behavior that in turn adds undesirable variables to a training program.

Referring again to FIG. 6, pellet retrieval arm 412 is connected to pellet motor 410. Pellet motor 410 may include any motor that causes pellet retrieval arm 412 to move from the position illustrated in FIG. 7A to the position illustrated in FIG. 7B. In one example, pellet motor 410 may include a servo motor. In one example, a servo motor may include a continuous rotation servo motor. It should be noted that servo motors typically do not have rotational encoders, so it may be difficult to know how far or fast the motor drive shaft has rotated based on the input to the motor or feedback from the motor. To overcome this limitation of servo motors, in one example system proximity sensors may be used to measure the rotational position pellet retrieval arm 412. In one example, pellet motor 410 may include a stepper motor equipped with rotational encoders. Stepper motors can be programmed to rotate pellet retrieval arm 412 to specific locations and encoders may send feedback to a computing device 300 regarding the precise rotational position of the motor shaft. The use of a stepper motor may improve the overall reliability of the motors and allow the robot to precisely position the pellets to the same location for each trial. Further, the use of a stepper motor may be more reliable and precise compared to a rotary system. In one example, it may be desirable that pellet retrieval arm 412 moves at a rotational speed of about 0.2 Hz.

It should be noted that in some example, a reach-guide 205 may be included between slit 202 and the tip pellet retrieval arm 412. In some cases, reach-guide 205 are important since some animals do not raise their paws to the pellet height and therefore cannot grasp pellets without the guide. That is, a reach-guide may be important, in some cases, to train rats to lift their paw to the correct height for grasping. Further, in some examples, a door may be located between slit 202 and the tip pellet retrieval arm 412. A door may be configured to block access to the pedestal. In one example, the door may be designed to block access with a down-to-up motion so that the animal's nose and forelimb are not injured by the mechanism. In one example, a rotating spiral door may be configured to gradually rise to block access to the pedestal, but quickly open to allow quick access to the pedestal without risk to the animal is used. The door mechanism may include a spiral shaped door attached to a door servo motor and a door sensor. The door servo motor may rotate the spiral door so that slit 202 is either open or blocked. The door sensor may detects the rotational location of the door.

When an animal attempts to reach and/or grab at a presented pellet, a pellet may be knocked from the tip of pellet presentation arm 412. That is, a grasp fail may occur. The exterior region of pellet hopper 402 includes a chute. As described below, a pellet passing through the chute is detected by pellet drop sensor 510. In order to properly record grasp fails, it is important that all dropped pellets are directed towards the chute. Pellet deflectors 408 positioned at the sides and bottom of pellet hopper 402 may force dropped pellets towards the chute. Pellet deflectors may be fully adjustable so that they can be positioned against task enclosure 200 front wall and floor such that no pellets escape pellet hopper 402. Pellet container 404 is positioned such that dropped pellets fall through the chute and into pellet container 404. This can prevent clogs in the chute. Further, collecting dropped pellets in pellet container 404 allows for confirmation of the number of grasp fails per session. That is, since the weight of pellet container 404 and the weight of each pellet is known, pellet container 404 can be weighed at the end of a session and the number of pellets in the pellet container 404 can be calculated. This calculated number can be compared with the number of grasp fails recorded by system (as described below). Further, pellet container 404 may also act as a dust collector. That is, pellets rub together to produce dust, which can accumulate over time. To reduce the amount of dust in pellet hopper 402 and facilitate cleaning, dust release holes are included in the bottom of the pellet hopper, as illustrated in FIGS. 7A-7B. The dust that drops from the holes is caught by pellet container 404.

It should be noted that pellet container 404 may further simplify converting the pellet retrieval system 400 between rat and mouse pellets. That is, as described above, since mouse pellets are considerably smaller than rat pellets, in some cases mouse pellets could circumvent pellet drop sensor 510 (e.g., circumvent the detection beam of a drop sensor) while passing through the chute and thus not always be detected by pellet drop sensor 510. Adapter 406, when in place, restricts the pellets to within a detection area of pellet drop sensor 510.

Once a pellet is presented, each attempt by an animal to retrieve the presented pellet may be evaluated. As described above, data from reach sensor 506, pellet present sensor 508, and pellet drop sensor 510 may be received by computing device 300. In one example, reach sensor 506, pellet present sensor 508, and pellet drop sensor 510 may include photo interrupter sensors. In the example illustrated in FIG. 6, “beams” of photo interrupter sensors are illustrated. In the example illustrated in FIG. 6, based on the data provided by reach sensor 506, pellet present sensor 508, and pellet drop sensor 510 each attempt may be evaluated as one of a pass, a reach fail, or a grasp fail. It should be noted that in other examples, attempts may be evaluated according to other classifications (e.g., a pass, a fail, or a cheat). Referring to FIG. 7B, reach sensor 506 detects if an animal reaches beyond slit 506. Data from reach sensor 506 may indicate attempts that fail to displace the pellet from the tip of pellet presentation arm 412, these attempts may be evaluated as a reach fail. Pellet present sensor 508 detects a pellet on the tip of pellet presentation arm 412. If a pellet is displaced from the tip of presentation arm 412, it may be determined that an attempt was made. As described above, pellet drop sensor 510 is located at the bottom of pellet hopper 404 and detects whether pellets displaced from the tip of pellet presentation arm 412 were dropped by the animal (these attempts may be evaluated as a grasp fail) or successfully obtained by the animal (these attempts may be evaluated as a pass). Together with the RFID coil 504, reach sensor 506, pellet present sensor 508, and pellet drop sensor 510 allow each trial to be analyzed and data to be sorted for each individual animal. It should be noted that since pellet present sensor 508 detects the presence or absence of a pellet on the pellet pedestal, visual cues (e.g., an LED light illuminating a pellet) or audible cues may be associated with pellet present sensor 508.

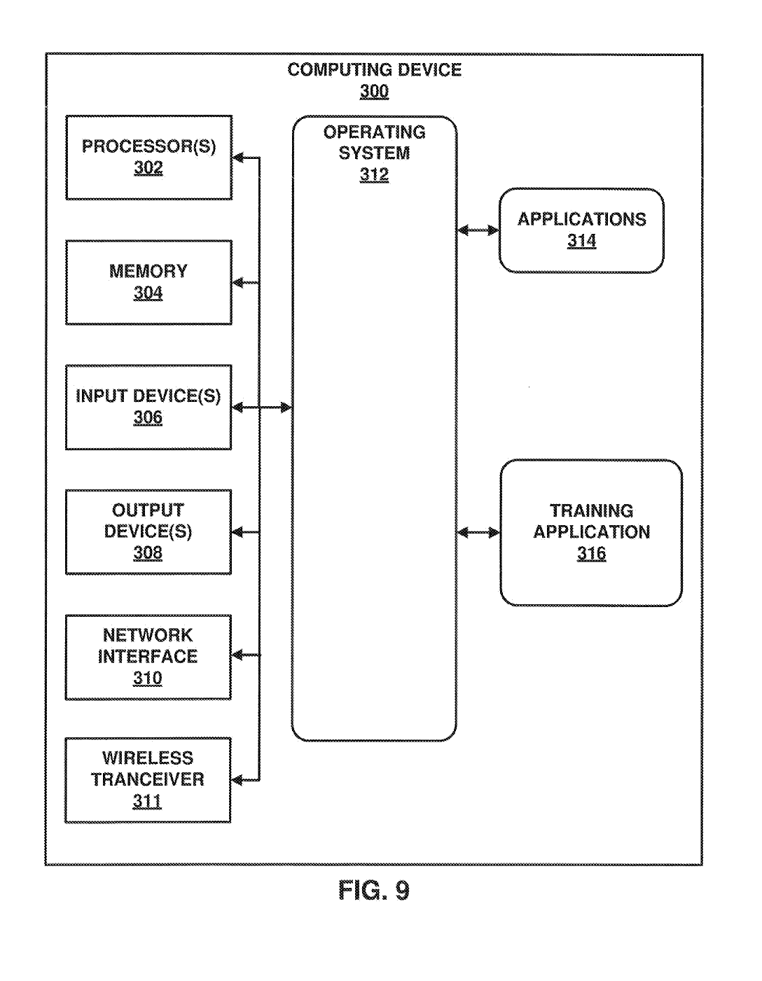

As described above, a pellet may be presented based on data from load cell 502. FIG. 8 is a flow chart illustrating an example technique for operating an example system of this disclosure. FIG. 8 illustrates a pellet being presented and an attempt being evaluated based on data provided by sensor system 500. The example technique illustrated in FIG. 8 may be used by an application, such as, for example, training application 316 described with respect to FIG. 9 to cause system 100 to train an animal.

Referring to FIG. 8, the techniques illustrated in the flowchart begin by retrieving and maintaining a pellet for presentation. That is, the pedestal is in a low position (illustrated in FIG. 7A) and if load cell 208 indicates that no rats are the front of task enclosure 200, the pedestal is to a raised position (illustrated in FIG. 7B). Data from pellet present sensor 508 confirms if the movement of pellet retrieval arm 512 successfully retrieved a pellet for presentation. If a pellet was not successfully retrieved for presentation, the pellet retrieval attempt may be repeated. If a pellet was successfully retrieved for presentation, data from load cell 502 may be used to determine if a single rat is at the front of task enclosure 200 or if multiple rats are at the front of task enclosure 200. If multiple rats are at the front of task enclosure 200, the presentation is aborted. If one rat is at the front of task enclosure 200, presentation may be maintained until reach sensor 506 detects a reach attempt. Upon a reach attempt being detected, data from pellet presentation sensor 508 may be used to determine if a reach fail occurred. In the example illustrated in FIG. 8, if a reach fail did occur, RFID coil 504 may output an animal ID. In the example illustrated in FIG. 8, if a reach fail did not occur, RFID coil 504 may output an animal ID and load cell 502 may output an animal weight. Further, sensor data from environmental sensors may be output. Data from pellet drop sensor 510 may then determine if a grasp fail or a pass occurred. In this manner, pellet presentation may be automated and attempts may be evaluated.

In one example, training an animal with the example systems described herein may be a four step process that takes less than a week. In one example, animals may remain within the system 100 throughout the training with unrestricted access to food, water, their home-cage 600A-600B, and task enclosure 200. In the first stage of training, the animals may be introduced to the task enclosure 200 via a home-cage. Pellets may be place on the floor of task enclosure 200 near slit 202. Upon placement in system 100 rats will typically begin by exploring their new home-cage along with brief trips within the task enclosure 200, where they often find the food pellets on the floor near slit 202. The rats soon discover slit 202 and detect the odor of more food pellets beyond slit 202, which leads to them exploring task enclosure 200 more frequently. In one training scenario, the pedestal may initially be placed sufficiently close to slit 202, so the animals can easily retrieve pellets simply by licking them from the pedestal. Most animals soon become proficient at retrieving pellets in this way and will typically consume several dozen to several hundred pellets a day. Once the animals have become accustomed to retrieving the easily accessible pellets beyond slit 202 (usually after a day), the pedestal may be moved progressively further from slit 202 until the pellets can no longer be licked from the pedestal. Since most animals are now driven to retrieve the tasty pellets, they soon attempt to grasp the pellets using their preferred forepaw. Typically, the transition between licking and grasping the pellets can take one to three days depending on the animal.

Next, in one example, once the animal has mastered grasping the pellets from the pedestal, the pedestal may be shifted from the center of slit 202 to either the left or right edge of slit 202, away from their preferred paw. This shift prevents the animal from using their non-preferred paw to grasp the pellets. Like humans, a preference to use one hand/paw is developed in rats, which can be easily determined prior to an injury or disease onset. After injury or disease the preferred paw might change, thus shifting the pellets left or right prevents the animals from grasping with their non-preferred paw. For example, when training a rat to grasp, if it is found that nearly all of its grasping attempts are made with its right paw, it can be concluded that the rat is right-paw dominant. In this case, pellets may be shifted to the left so that the rat can now grasp only with its dominant right paw. Following an injury to the right side of the spinal cord, the right paw of the animal is partially paralyzed. Given the option the animal would likely try to grasp with its uninjured paw rather than its partially paralyzed paw. However, since the pellets are shifted to the left, the animal must use its dysfunctional paw to grasp pellets. Forcing the animals to use their formerly preferred paw is important for rehabilitation and testing of motor function of this paw specifically. In uninjured animals, transitioning from center to right-shifted or left-shifted pellets usually takes about one day.

Finally, once the animals can retrieve pellets from the left/right shifted pedestal, the pellet presentation mechanism is activated. As described above, pellet presentation mechanism requires the animal to move to the back of task enclosure 200 to initiate a new trial, thus completing the SPG task. The animals typically learn to move to the back of task enclosure 200 in less than a day of the pellet presentation mechanism being activated. Once trained, the animals may remain within the automated training environment to maintain and improve SPG proficiency or for rehabilitation purposes if the nervous system of the animals is damaged (e.g., stroke or spinal cord injury). Thus, example system 100 represents an example of a system configured to train laboratory animals to perform a specific task.

As described above, computing device 300 may be configured to receive data from sensor system 500 cause pellet retrieval system 400 to perform an action and/or evaluate attempts based on sensor data computing device 300. FIG. 9 is a block diagram illustrating an example computing device that may implement one or more techniques of this disclosure. Computing device 300 is an example of a computing device that may be configured to and execute one or more applications (e.g., training application 316). Computing device 300 may include or be part of a portable computing device (e.g., a mobile phone, netbook, laptop, personal data assistant (PDA), or tablet device) or a stationary computer (e.g., a desktop computer, or set-top box), or may be another computing device. Computing device 300 includes processor(s) 302, memory 304, input device(s) 306, output device(s) 308, network interface 310, and wireless transceiver 311. Each of processor(s) 302, memory 304, input device(s) 306, output device(s) 308, network interface 310, and wireless transceiver 311 may be interconnected (physically, communicatively, and/or operatively) for inter-component communications. Operating system 312, applications 314, and training application 316 may be executable by computing device 300. It should be noted that although example computing device 300 is illustrated as having distinct functional blocks, such an illustration is for descriptive purposes and does not limit computing device 300 to a particular hardware architecture. Functions of computing device 300 may be realized using any combination of hardware, firmware and/or software implementations.

Processor(s) 302 may be configured to implement functionality and/or process instructions for execution in computing device 300. Processor(s) 302 may be capable of retrieving and processing instructions, code, and/or data structures for implementing one or more of the techniques described herein. Instructions may be stored on a computer readable medium, such as memory 304. Processor(s) 302 may be digital signal processors (DSPs), general purpose microprocessors, application specific integrated circuits (ASICs), field programmable logic arrays (FPGAs), or other equivalent integrated or discrete logic circuitry.

Memory 304 may be configured to store information that may be used by computing device 300 during operation. Memory 304 may be described as a non-transitory or tangible computer-readable storage medium. In some examples, memory 304 may provide temporary memory and/or long-term storage. In some examples, memory 304 or portion thereof may be described as volatile memory, i.e., in some cases memory 304 may not maintain stored contents when computing device 300 is powered down. Examples of volatile memories include random access memories (RAM), dynamic random access memories (DRAM), and static random access memories (SRAM). Memory 304 may be internal or external memory and in some examples may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories.

Input device(s) 306 may be configured to receive input from a user operating computing device 300. Input from a user may be generated as part of a user running one or more software applications, such as training application 316. Input device(s) 306 may include a touch-sensitive screen, track pad, track point, mouse, a keyboard, a microphone, a video camera, any combination of the sensors described above, or any other type of device configured to receive input from a user. In one example, sensors may be monitored and motors (or LED lights) may be controlled via circuit boards attached to computing device using a combination of software/hardware/firmware. In one example, system 100 may include a camera to record the activity of the animals while they perform the task. The camera may be motion-activated, thus limiting filming (i.e., recording) to when the animal is performing the task. The motion-activation sensitivity and timing can be changed so that more or less of the task is filmed (e.g., film only the grasping action versus filming the animal as it approaches the slit and for several seconds after a grasping attempt is made). In another example, video acquisition may be controlled by monitoring changes in light intensity from the streaming video. In another example, video acquisition may be controlled by programming software to trigger video file saving. For example, software can be programmed to send a signal to video acquisition software when the pellet sensor detects that a grasp attempt has been made. It should be noted that video may be used to further assess evaluated attempts. In example, camera may include a Foscam day/night digital cameras (FI9821 W) equipped with integrated infrared LEDs for dark-cycle recording and video may be continuously acquired using BlueIris software (v. 3.5; Perspective Software). In one example high-speed video may be acquired using an IMPERX (IPX-VGA210) camera and may be used for grasp motion analysis.

Output device(s) 308 may be configured to provide output to a user operating computing device 300. Output may include tactile, audio, or visual output generated as part of a user running one or more software applications, such as training application 316. Output device(s) 308 may include a touch-sensitive screen, sound card, a video graphics adapter card, or any other type of device for converting a signal into an appropriate form understandable to humans or machines. Additional examples of an output device(s) 308 may include a speaker, a cathode ray tube (CRT) monitor, a liquid crystal display (LCD), or any other type of device that can provide output to a user. In the example where computing device 300 is a mobile device, output device(s) 308 may be an LCD or organic light emitting diode (OLED) display configured to receive user touch inputs, such as, for example, taps, drags, and pinches.

Network interface 310 may be configured to enable computing device 300 to communicate with external devices via one or more networks. Network interface 310 may be a network interface card, such as an Ethernet card, an optical transceiver, a radio frequency transceiver, or any other type of device that can send and receive information. Network interface 310 may be configured to operate according to one or more of the communication protocols. Wireless transceiver 311 may be a wireless transceiver configured to send and receive data. In one example, wireless transceiver 311 and network interface 310 may be integrated.

Operating system 312 may be configured to facilitate the interaction of applications, such as application 314 and training application 316, with processor(s) 302, memory 304, input device(s) 306, output device(s) 308, network interface 310, and wireless transceiver 311 of computing device 300. Operating system 312 may be an operating system designed to be installed on laptops and desktops. For example, operating system 312 may be a Windows operating system, Linux, or Mac OS. In another example, if computing device 300 is a mobile device, such as a smartphone or a tablet, operating system 312 may be one of Android, iOS or a Windows mobile operating system. In another example, if computing device 300 is an embedded computer that is integrated into the robot hardware, such as a single board computer, operating system 312 may be one of Debian GNU, Linux, Unix, or any Unix-like computer operating system. An example of a single board computer includes PhidgetSBC3.

Applications 314 may be any applications implemented within or executed by computing device 300 and may be implemented or contained within, operable by, executed by, and/or be operatively/communicatively coupled to components of computing device 300. Applications 314 may include instructions that may cause processor(s) 302 of computing device 300 to perform particular functions. Applications 314 may include algorithms which are expressed in computer programming statements, such as, for loops, while-loops, if-statements, do-loops, etc. Applications may be developed using a programming language. Examples of programming languages include Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, Python, UNIX Shell, Visual Basic or Visual Basic Script, Virtual Reality Markup Language (VRML), ColdFusion™ and other compilers, assemblers, and interpreters.

Training application 316 is an example of an application configured to enable a laboratory animal to be trained according to the techniques described herein. In one example training application 316 may include robot-controller software for controlling an automated system (e.g., the systems described above) and may be written in Java using Neat Beans IDE 7.3.

It should be noted that in one example, computing device 300 may include micro-controllers that can store and/or transmit data back to a central computer to control motor and to collected data is collected by micro-controllers. In some cases, micro-controllers may be more stable and easier to implement, especially when multiple systems are being using in a single facility. Further, micro controllers enable systems to be deployed without requiring a computer to run (i.e., stand-alone). As described above, mouse pellets are smaller than rat pellets and mice have smaller arms that can move faster than rat arms. As a result, in some cases, software cannot collect data fast enough from the reaching fail sensor and dropped pellet sensors. In one example, logical circuit gates may be used to increases the sensor read frequencies and eliminates missed events.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A device for training animals, the device comprising:
a task enclosure;
a pellet retrieval system;
a sensor system; and
a computing device configured to receive data from the sensor system and cause pellet retrieval system to present a pellet to an animal.

2. The device of claim 1, wherein the computing device is configured to cause pellet retrieval system to present a pellet to an animal based on an animal performing a single pellet grasping task.

3. The device of claim 1, wherein the position of a presented pellet may be adjusted to a desired location.

4. The device of claim 1, wherein the task enclosure is operably coupled to one or more home-cages.

5. The device of claim 1, wherein the sensor system includes an animal location sensor.

6. The device of claim 5, wherein an animal location sensor includes a load cell located at one end of the task enclosure.

7. The device of claim 6, wherein an animal location sensor includes a radio frequency identifier module.

8. The device of claim 6, wherein the computing device is configured to cause pellet retrieval system to present a pellet to an animal based on data from load cell indicating that a single animal is present on the load cell.

9. The device of claim 1, wherein the sensor system includes a reach sensor configured to indicate whether an animal reaches for a presented pellet.

10. The device of claim 9, wherein the pellet retrieval system includes a pellet retrieval arm configured to accommodate a pellet and wherein the sensor system includes a pellet present sensor configured to indicate whether a pellet is present for presentation.

11. The device of claim 10, wherein the sensor system includes a pellet drop sensor configured to indicate whether a pellet is dislodged from the pellet retrieval arm.

12. The device of claim 10, wherein the pellet retrieval arm is operable coupled to a pellet motor.

13. The device of claim 11, wherein the pellet retrieval system includes pellet container positioned such that pellets dislodged from the pellet retrieval arm are collected in pellet container.

14. A method for training animals, the method comprising:
coupling a home-cage to in device including
a task enclosure,
a pellet retrieval system,
a sensor system, and
a computing device configured to receive data from the sensor system and cause pellet retrieval system to present a pellet to an animal; and
provide access to the device from the home-cage according to a desired training schedule.

15. The method of claim 14, further comprising adjusting the position of the pellet presentation to an animal according to a training stage.

16. A non-transitory computer-readable storage medium comprising instructions stored thereon that upon execution cause one or more processors of a device to:
cause a pellet retrieval arm to move such that a pellet moves to a presentation position; and
evaluate an attempt by an animal to reach the pellet located at the presentation position.

17. The non-transitory computer-readable storage medium of claim 16, wherein the instructions further cause one or more processors of a device to determine whether one or more animals are located in proximity to the pellet retrieval arm and upon, determining that more than one animal is located in proximity to the pellet retrieval arm, cause a pellet retrieval arm to move such that a pellet moves to a position other than the presentation position.

18. The non-transitory computer-readable storage medium of claim 16, wherein evaluating an attempt by an animal to reach the pellet located at the presentation position includes determining whether an attempt is a reach fail attempt.

19. The non-transitory computer-readable storage medium of claim 18, wherein evaluating an attempt by an animal to reach the pellet located at the presentation position includes determining whether an attempt is a grasp fail attempt.

20. The non-transitory computer-readable storage medium of claim 19, wherein evaluating an attempt by an animal to reach the pellet located at the presentation position includes determining whether an attempt is a pass attempt.
